(19) United States
(12) Patent Application Publication
(10) Pub. No.: US 2025/0345709 A1
(43) Pub. Date: Nov. 13, 2025

(54) TECHNIQUES FOR GENERATING DYNAMIC NARRATIVES IN GAMING ENVIRONMENTS

(71) Applicant: AUTODESK, INC., San Francisco, CA (US)

(72) Inventors: Yi WANG, Richmond, CA (US); David LEDO MAIRA, Toronto (CA); Qian ZHOU, San Francisco, CA (US)

(21) Appl. No.: 19/186,396

(22) Filed: Apr. 22, 2025

Related U.S. Application Data
(60) Provisional application No. 63/644,791, filed on May 9, 2024.

(51) Int. Cl. A63F 13/67; G06N 3/0475

(52) U.S. Cl. CPC A63F 13/67; G06N 3/0475

(57) ABSTRACT

One embodiment sets forth a technique for generating dynamic narratives in gaming environments. According to some embodiments, the technique includes the steps of receiving game environment data associated with a game environment and narrative outline data associated with the game environment; identifying, based on the narrative outline data, a plurality of predefined conditions for updating the game environment data; determining, based on the game environment data, that at least one predefined condition included in the plurality of predefined conditions is satisfied; generating, via a generative artificial intelligence (AI) model, updated narrative outline data based on the game environment data and the narrative outline data; and modifying the game environment data based on the updated narrative outline data to generate updated game environment data.

### CROSS-REFERENCE TO RELATED APPLICATIONS

The present application claims the benefit of U.S. Provisional Application titled, “CO-AUTHORING DYNAMIC PLOT WITH LARGE LANGUAGE MODEL BASED CHARACTER SIMULATION VIA NARRATIVE PLANNING”, filed on May 9, 2024, and having Ser. No. 63/644,791. The subject matter of this related application is hereby incorporated herein by reference.

### BACKGROUND

### Field of the Various Embodiments

Embodiments of the present disclosure relate generally to computer science, artificial intelligence, and complex software applications, and, more specifically, to techniques for generating dynamic narratives in gaming environments.

### DESCRIPTION OF THE RELATED ART

Automated narrative generation in interactive experiences, such as video games, enhances player engagement by creating dynamic storylines that evolve based on in-game conditions and player choices. Traditional approaches to automated narrative generation typically rely on symbolic narrative planning, where story progression is governed by predefined logical structures and rules. These structured frameworks allow developers to map branching storylines systematically, which can help promote events to unfold in a controlled sequence based on players' actions. However, such approaches can be rigid, and can limit the adaptability of narratives to emergent gameplay and complex player interactions.

Existing approaches to automated narrative generation often involve decision trees, finite state machines, or rule-based scripting systems. These approaches require developers to manually define possible story paths that specify conditions under which different narrative events should occur. Some approaches introduce probabilistic elements to create variation, but still operate within a constrained set of predefined possibilities. While such approaches allow for structured and predictable storytelling, they require extensive upfront effort to design and maintain, which makes it difficult to scale narratives or introduce meaningful dynamism in response to players' choices.

On drawback of conventional approaches involves the difficulty in translating high-level narrative objectives into concrete story elements that seamlessly integrate characters, locations, and events. In particular, conventional approaches struggle to reconcile abstract storytelling goals with game mechanics in a way that ensures both narrative fluidity. Additionally, incorporating player-driven choices into the narrative without introducing inconsistencies presents a technical challenge, as mechanisms are required for dynamically adjusting story components while maintaining logical coherence.

Another drawback of conventional approaches involves the lack of consistency and coordination across character interactions. While autonomous character behavior can enhance realism, such behavior often fails to contribute meaningfully to a unified story arc. Without a structured mechanism for synchronizing character actions, emergent interactions can lead to narrative dissonance, where character-driven subplots undermine or contradict the central storyline. This issue is exacerbated in multi-character scenarios, where interactions need to align toward a coherent overarching goal.

Yet another drawback of conventional approaches involves the difficulty in maintaining real-time adaptability in response to evolving game states. In particular, while predefined narrative structures can provide a level of control, they often lack the flexibility to accommodate unpredictable player choices and emergent gameplay scenarios. Without effective mechanisms for dynamically adjusting the narrative, story progression can become disjointed, which can disrupt player immersion and reduce the effectiveness of interactive storytelling.

Yet another drawback of conventional approaches involves the reliance on predefined narrative logic, which can limit scalability and extensibility. Consequently, expanding a narrative system to support new characters, settings, or interactions often requires extensive manual effort to define new rules and update existing structures. This reliance on static frameworks makes it difficult to create expansive, dynamic storytelling experiences that evolve over time.

As the foregoing illustrates, there is a need for improved narrative generation systems that address the challenges of high-level story control, narrative coherence, and real-time adaptability within gaming environments.

### SUMMARY

One embodiment sets forth a method for generating dynamic narratives in gaming environments. According to some embodiments, the method can include the steps of receiving game environment data associated with a game environment and narrative outline data associated with the game environment; identifying, based on the narrative outline data, a plurality of predefined conditions for updating the game environment data; determining, based on the game environment data, that at least one predefined condition included in the plurality of predefined conditions is satisfied; generating, via a generative artificial intelligence (AI) model, an updated narrative outline based on the game environment data and the narrative outline data; and modifying the game environment data based on the updated narrative outline to generate updated game environment data.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques relative to conventional approaches is that the disclosed techniques provide centralized control over emergent narratives while preserving the autonomy of game characters. In particular, the disclosed techniques enable narrative coherence to be maintained, including when multiple characters interact dynamically in real-time. Another technical advantage is that the disclosed techniques eliminate the need for pre-scripted branching storylines by enabling abstract, high-level story outlines to be dynamically instantiated into character actions, which increases the scalability of narrative generation. Additionally, the disclosed techniques enable real-time integration of player actions, thereby allowing stories and narratives to evolve based on both character simulations and player input.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of various embodiments.

FIG. 2 illustrates a conceptual diagram of different data and software entities that can be managed by the server device of FIG. 1, according to some embodiments.

FIGS. 3A-3D illustrate conceptual diagrams for generating dynamic narratives in an example gaming application of FIG. 1, according to various embodiments.

FIG. 4 illustrates a conceptual diagram of an interplay between a plan generator and a plan reviewer and verifier of FIG. 2, according to some embodiments.

FIG. 5 illustrates a conceptual diagram of alternative generated acts relative to those discussed in conjunction with FIGS. 3A-3D, according to some embodiments.

FIG. 6 illustrates a method for generating dynamic narratives in gaming environments, according to some embodiments.

FIG. 7 is an illustration of a computing device that can implement the functionalities of the entities illustrated in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

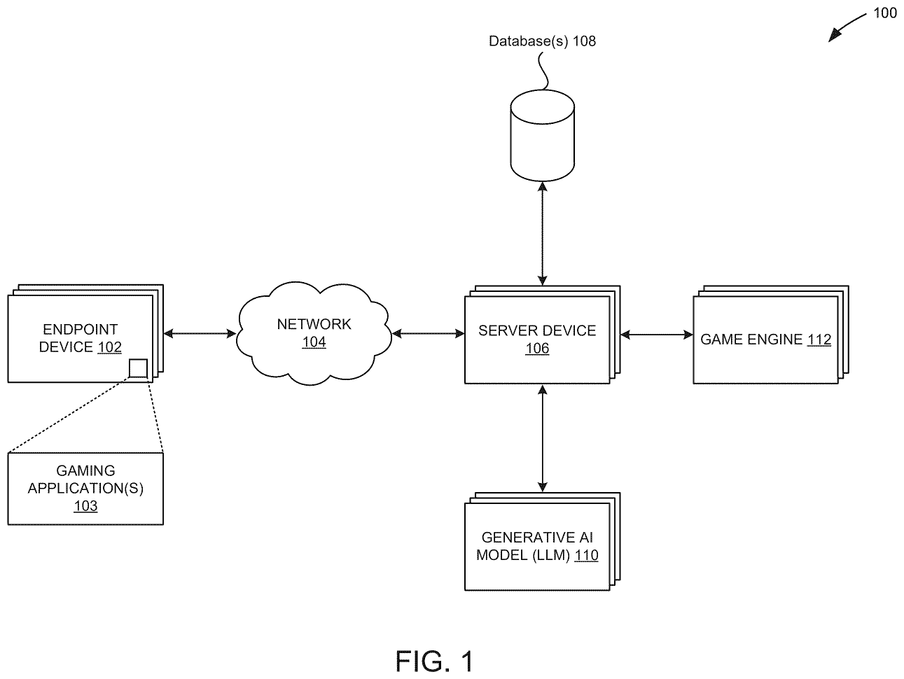

FIG. 1 is a conceptual illustration of a system 100 configured to implement one or more aspects of the various embodiments. As shown, the system 100 includes at least one endpoint device 102, at least one server device 106, at least one database 108, at least one generative AI model 110, and at least one game engine 112, each of which are connected via a communications network 104. The communications network 104 can represent, for example, any technically feasible network or number of networks, including a wide area network (WAN) such as the Internet, a local area network (LAN), a Wi-Fi network, a cellular network, or a combination thereof.

A given endpoint device 102 can represent a computing device (e.g., a desktop computing device, a laptop computing device, a mobile computing device, etc.) operated by a user. As shown in FIG. 1, at least one gaming application 103 can be installed and execute on the endpoint device 102. The gaming applications 103 can represent various types of gaming applications, including web browser-based gaming applications, installed gaming applications, and other interactive entertainment applications. According to some embodiments, the web browser-based gaming applications can operate within an internet browser environment, leveraging web technologies such as HTML5, WebGL, and JavaScript to render graphics and manage gameplay logic. These applications can dynamically load assets and game logic from remote sources, allowing for seamless updates and cross-platform compatibility. Installed gaming applications, on the other hand, can include games that are locally installed on the endpoint device 102, which can utilize more advanced graphics processing capabilities and access local storage for performance optimization. Such gaming applications may range from mobile games running on smartphones or tablets to high-performance gaming software executed on desktop computers or gaming consoles. It is noted that the foregoing examples are not meant to be limiting, and that the gaming applications 103 can include any amount, type, form, etc., of gaming/interactive application(s), consistent with the scope of this disclosure.

According to some embodiments, the gaming applications 103 can be configured to communicate with the game engine 112, which can be implemented by the server device 106, accessible to the server device 106 via the communications network 104, etc. In that regard, the server device 106 and the game engine 112 can be collectively referred to herein as the server device 106. This approach enables a range of functionalities to be implemented, including multiplayer synchronization, content streaming, and cloud-based game logic execution. For instance, in a multiplayer gaming environment, an installed gaming application can send player actions to the server device 106, which then processes such actions and updates game state information accordingly before transmitting updated game data back to the gaming application 103. Similarly, a web browser-based game may continuously retrieve new game assets, levels, or event triggers from the server device 106, which can help ensure that the gameplay experience remains dynamic and responsive to real-time events.

According to some embodiments, the exchange of data between the gaming applications 103 and the server device 106 can be optimized through various content delivery techniques. For example, in some implementations, the server device 106 may serve pre-rendered assets, physics calculations, or AI-generated responses to reduce the computational load on the endpoint device 102. Such an approach can be particularly beneficial for endpoint devices 102 having limited processing capabilities, such as mobile phones or lightweight computing platforms. Additionally, gaming applications 103 can be designed to send periodic updates or telemetry data to the server device 106, enabling real-time analytics, player behavior tracking, and adaptive game difficulty adjustments to be implemented. By facilitating bi-directional data flow, the gaming applications 103 and the server device 106 can work in tandem to provide a seamless and engaging user experience across different device types and gaming environments.

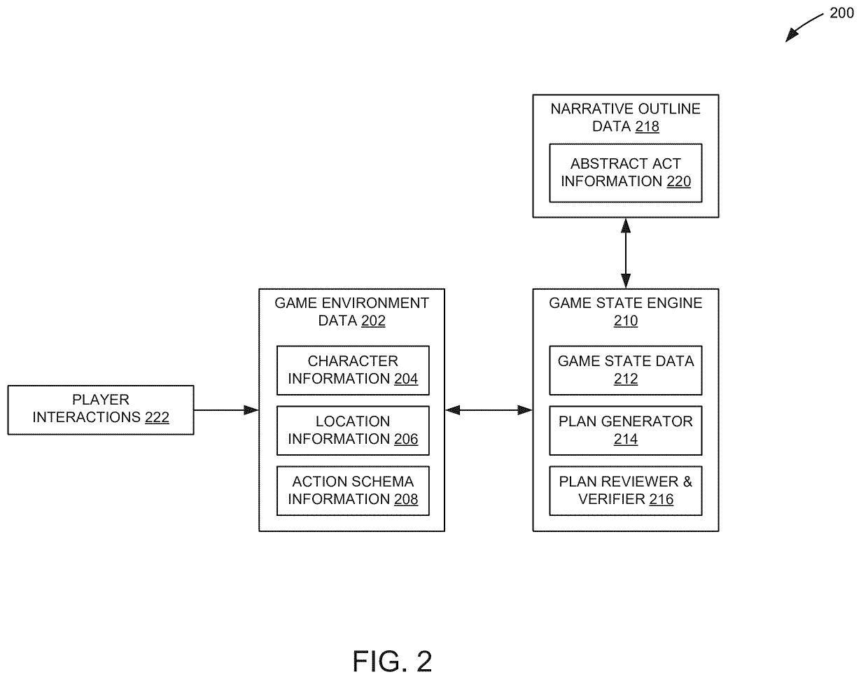

As described herein, the server device 106 can configured to receive, process, manage, etc., game environment data, narrative outline data, and AI-generated content for a given gaming application 103. The game environment data can be established, maintained, etc., by tracking character locations, active goals, and player interactions within the gaming application 103. The server device 106 can also manage character attributes, which define character traits, goals, emotional conditions, character behaviors, etc., to maintain consistency in character interactions and narrative progression. The server device 106 can also manage location data, which can include, for example, designated regions, terrain classifications, environmental factors, spatial coordinates where character interactions occur, etc., can also be maintained. The server device 106 can also manage action schemas, which can be implemented to specify different actions that characters can perform, including movement, object manipulation, dialogues, and the like. The server device 106 can also manage abstract acts, which can be implemented to provide high-level narrative outlines that define events, story transitions, prerequisite conditions for narrative advancement, and the like. It is noted that the foregoing examples are not meant to be limiting, and that the server device 106 can be configured to process, manage, etc., any amount, type, form, etc., of information related to a given gaming environment, at any level of granularity, consistent with the scope of this disclosure. A more detailed breakdown of different approaches for managing the foregoing information is provided below in conjunction with FIG. 2.

According to some embodiments, the server device 106 can utilize one or more generative AI models 110 to process game environment data 202 and narrative outline data 218 to generate updated narrative outline data 218, which can include modifications to character behaviors, dialogues, interactions, and the like. According to some embodiments, the updated narrative outline data 218 can align with predefined constraints, including character goals, game environment conditions, player choices, and the like. It is noted that the foregoing examples are not meant to be limiting, and that the narrative outline data 218 can include any amount, type, form, etc., of information that can be used to implement any number, type, form, etc., of aspects associated with the gaming application 103, at any level of granularity, consistent with the scope of this disclosure.

As a brief aside, it should be appreciated that the generative AI model 110 can be implemented as a large language model (LLM), a neural network-based system, a transformer-based text generation model, a hybrid AI architecture combining reinforcement learning and symbolic reasoning, or the like. It is noted that the foregoing examples are not meant to be limiting, and that the generative AI model 110 can represent any number, type, form, etc., of generative AI model(s), consistent with the scope of this disclosure.

According to some embodiments, the game engine 112 facilitates gameplay for the gaming application 103 by rendering characters, game environments, character interactions, and the like. The game engine 112 processes both player inputs received from the endpoint device 102 and outputs received from the generative AI model 110 to provide integration of generated data within the game. The game engine 112 also facilitates real-time adjustments based on evolving character interactions. The game engine 112 can include scripting systems, animation controllers, audio engines, physics engines, etc., to simulate character movement, character interactions, and game environment. The game engine 112 can be a standalone application or integrated within cloud-based game streaming services. It is noted that the foregoing examples are not meant to be limiting, and that the game engine 112 can manage any amount, type, form, etc., of information, and can implement any number, type, form, etc., of sub-engines, at any level of granularity, consistent with the scope of this disclosure.

According to some embodiments, the databases 108 can be used to store game environment data and/or player interaction logs received from the endpoint device 102, including player choices, character movements, dialogue selections for game progression, and the like. The server device 106 can interface with the databases 108 to retrieve and updating game state data, including character information, goal progressions, and game environment changes, to maintain consistency in narrative execution. Additionally, the databases 108 exchange information with the generative AI model 110 by providing stored game data, character logs, predefined constraints, etc., that the generative AI model 110 can utilize to generate narratives, character dialogues, character actions, and the like. The AI-generated outputs, such as updated narrative outlines and modified character actions, can be managed using the databases 108 to ensure consistency across gameplay and to support dynamically evolving narratives.

It will be appreciated that the endpoint device 102, the server device 106, the databases 108, the generative AI model 110, and game engine 112 described in conjunction with FIG. 1 are illustrative, and that variations and modifications are possible. For example, the connection topologies, including the number of CPUs and memories, may be modified as desired, and, in certain embodiments, one or more components shown in FIG. 1 not be present, or may be combined into fewer components. Further, in certain embodiments, one or more components shown in FIG. 1 may be implemented as virtualized resources in one or more virtual computing environments and/or cloud computing environments.

FIG. 2 illustrates a conceptual diagram 200 of different data and software entities that can be managed by the server device 106 of FIG. 1, according to some embodiments. As shown in FIG. 2, the server device 106 can manage, for a given gaming application 103, game environment data 202, narrative outline data 218, and player interaction 222. The game environment data 202 can store predefined and dynamically generated data related to character information 204, location information 206, and action schema information 208. The narrative outline data 218 can include predefined abstract acts 220. The player interactions 222 can represent input data (e.g., control commands, voice commands, etc.) received from an endpoint device 102 executing the gaming application 103. As shown in FIG. 2, the server device 106 can implement a game state engine 210, which can be configured to manage game state data 212, a plan generator 214, and a plan reviewer and verifier 216. The game state engine 210 can represent the game engine 112 described herein or can represent an auxiliary game engine that complements the game engine 112.

According to some embodiments, the character information 204 includes personality traits, goals, and other attributes that are received by the plan generator 214. For example, a predefined goal of a character can influence AI-generated dialogue responses and interactions with other characters or non-player characters (NPCs). According to some embodiments, the location information 206 includes spatial configurations, terrain properties, interaction locales, etc., which enable the game state engine 210 to determine whether characters meet the spatial requirements for triggering events or progressing through narratives of the gaming application 103. According to some embodiments, the action schema information 208 includes a set of allowable actions (e.g., movements, interactions with objects or characters, communications, etc.) that characters can carry out within the gaming application 103.

According to some embodiments, the game state engine 210 monitors the current game state data 212 and identifies whether predefined prerequisite conditions contained within the narrative outline data 218 have been satisfied. According to some embodiments, the game state data 212 includes continuously updated data such as locations, actions, goals, etc., of characters informed by the game environment data 202. Upon detecting that one or more conditions have been satisfied, the game state engine 210 can trigger the plan generator 214 and the plan reviewer and verifier 216 to generate and evaluate potential narrative outlines. The game state engine 210 can also compare updated game state data 212 against requirements associated with the abstract acts 220 so that the execution of one or more acts can be prioritized when multiple conditions are satisfied.

When the prerequisite conditions for an abstract act 220 are fulfilled, the game state engine 210 can trigger the plan generator 214 to query the generative AI model 110 to generate new events such as character actions, dialogues, or sequences of events that align with constraints specified in the narrative outline data 218. In particular, the plan generator 214 receives game environment data 202 including character information 204, location information 206, and action schema information 208, as well as the relevant abstract acts 220. The outputs generated by the generative AI model 110 are then transmitted to the plan reviewer and verifier 216 for validation against the predefined conditions.

According to some embodiments, the plan reviewer and verifier 216 evaluates the data received from the plan generator 214 to confirm consistency with predefined game constraints including character goals, action feasibility within a location, or other constraints indicated by narrative outline data 218. If conflicts are detected, e.g., if the generated event contradicts with a goal of a character or occurs in a location without satisfying the constrains, then plan reviewer and verifier 216 can request modifications from plan generator 214 to promote narrative coherence and consistency. When the plan reviewer and verifier 216 validates the output generated by the plan generator 214, updated narrative outline data can applied to the game environment data 202.

According to some embodiments, the narrative outline data 218 includes a set of abstract acts 220, which define high-level narrative goals and prerequisite conditions that govern narrative outline progression within the gaming application 103. Each abstract act 220 can include, for example, high-level narrative goals, transitional elements guiding the flow between narrative events, constraints for providing consistency with game environment data 202, and the like. In addition, the abstract acts 220 can allow the game state engine 210 to adaptively instantiate specific character actions or dialogues based on updated game state data 212, and preserve coherence throughout the narratives of the gaming application 103.

The player interactions 222 represent real-time player inputs, such as selecting dialogue choices, moving characters, interacting with objects, etc., which are received by the game state engine 210 for processing. In response, the game state engine 210 updates the game state data 212 to capture the latest player-driven actions. If the updated game state data 212 satisfies conditions defined by one or more abstract acts 220, then the plan generator 214 queries the generative AI model 110 to generate new events or to modify existing narrative outlines. For example, when a player interacts with an NPC, the game state engine 210 can capture the corresponding interaction and update the game state data 212. The updated game state data 212 can then be evaluated by the game state engine 210 to determine whether the plan generator 214 should generate a new event based on the specific player choice and any relevant prerequisite conditions specified in the narrative outline data 218. Plan reviewer and verifier 216 then evaluates each of the generated events before the changes are applied to the game environment data 202.

The game environment data 202 integrates both the player interactions 222 and any validated outputs from plan generator 214, including character actions, dialogue sequences, or environmental updates. Following approval by plan reviewer and verifier 216, the updated game environment data 202 captures character states and/or modifies in-game environmental conditions to reflect the latest progression in the narrative of the gaming application 103. In parallel, the game state data 212 can be updated to reflect the changes, thereby enabling subsequent generated events by plan generator 214 and player interactions 222 to be adoptive and coherent.

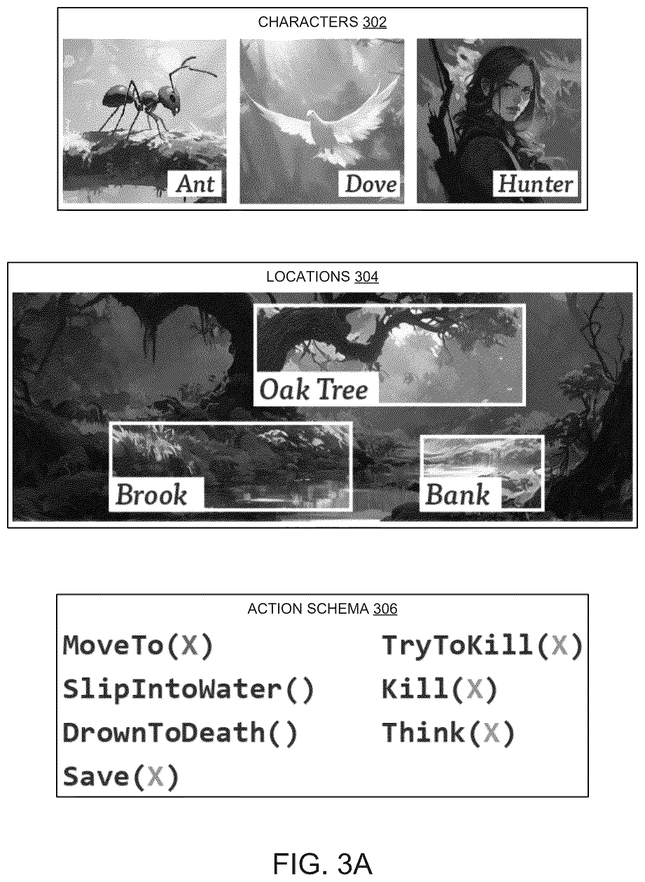

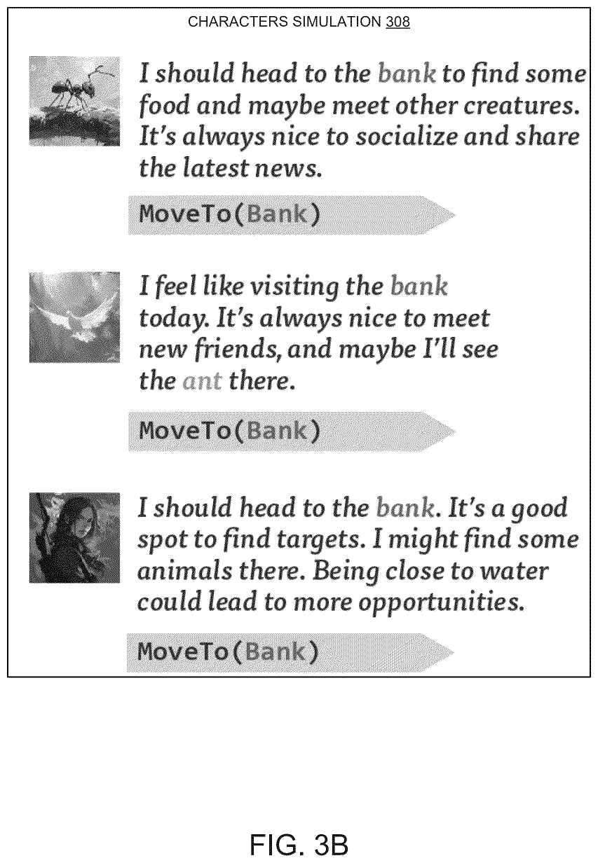

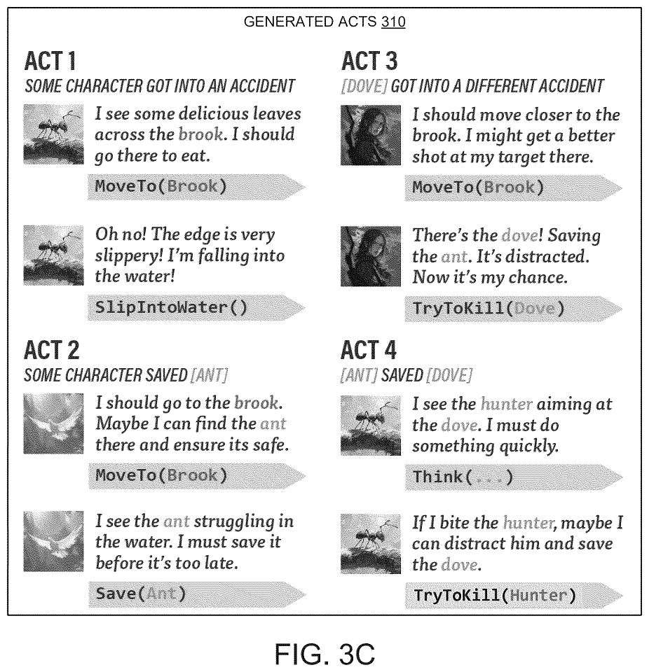

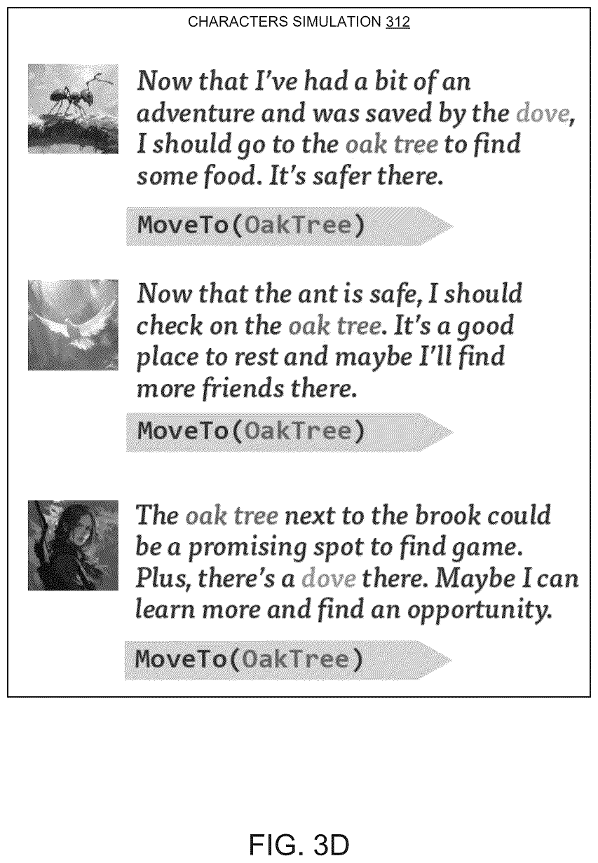

FIGS. 3A-3D illustrate conceptual diagrams for generating dynamic narratives in an example gaming application 103, according to various embodiments. Specifically, FIG. 3A illustrates examples of narrative outline elements that define the game environment, character information, etc., of the example gaming application 103. As shown in FIG. 3A, such narrative outline elements can include characters 302, locations 304, and an action schema 306. As shown in FIG. 3A, the characters 302 define the individual characters within the gaming application 103, such as an Ant, a Dove, and a Hunter. Each character is associated with specific attributes, including predefined traits, goals, and names. Information for the characters 302 can be stored within the characters information 204 in the game environment data 202.

Additionally, as shown in FIG. 3A, the locations 304 define locations where character interactions occur, including an Oak Tree, a Brook, and a Bank. Information for the locations 304 can be stored within the locations information 206 in the game environment data 202. The game state engine 210 monitors the locations of characters and determines whether the locations of the characters satisfy prerequisite conditions required to trigger plan generator 214. For example, a character being located at the Brook can be necessary to activate a predefined event such as slipping into water.

As shown in FIG. 3A, characters can perform different actions, including movement, object manipulation, or communication. For example, action schema 306 includes actions such as MoveTo(X), SlipIntoWater( ) DrownToDeath( ) Save(X), TryToKill(X), Kill(X), and Think(X). information for the action schema 306 can be stored within the action schema information 208 in the game environment data 202. The game state engine 210 can monitor the actions of the characters and determine whether the actions of the characters satisfy prerequisite conditions to trigger plan generator 214 to perform one or more operations. For example, if an abstract act 220 specifies that a character should be saved following an action, then the plan generator 214 can generate the Save(X) action, thereby enabling the resulting gameplay to remain consistent with high-level narrative goals.

The execution of actions within the gaming application 103 can be monitored and evaluated by the plan reviewer and verifier 216 to ensure that generated actions satisfy constraints of the gaming application 103. For example, the plan reviewer and verifier 216 can evaluate whether generated actions are feasible based on locations of characters, whether generated actions satisfy established character attributes, whether generated actions satisfy narrative coherence, and so on. If a generated action does not satisfy the constraints, then the plan reviewer and verifier 216 can request revisions from the plan generator 214 before the action is reflected within the gaming application 103.

FIG. 3B illustrates a characters simulation 308 that shows how plan generator 214 can generate character actions based on character information 204, location information 206, and the like. As shown, FIG. 3B presents example character simulations for Ant, Dove, and Hunter, each demonstrating actions within the gaming application 103. In the example illustrated in FIG. 3B, the characters simulation 308 utilizes generative AI model 110 outputs to generate character actions based on characters goals, traits, locations, etc. For example, Ant considers, “I should head to the bank to find some food and may be meet other creatures . . . It's always nice to socialize and share the latest news . . . “. Subsequently, the plan generator 214 queries the generative AI model 110 for generating the MoveTo (Bank) action. Similarly, Dove considers, “I feel like visiting the bank today . . . It's always nice to meet new friends, and may be I'll see the Ant . . . “, which prompts the generative AI model 110 to generate the MoveTo (Bank) action. Hunter, considers, “I should head to the bank . . . It's a good spot to find targets . . . I might find some animals there . . . Being close to water could lead to more . . . “, which prompts generative AI model 110 to generate the MoveTo (Bank) action.

As described in FIG. 2, the game state engine 210 monitors changes in the game environment data 202 to evaluate whether predefined conditions for an abstract act 220 have been satisfied. When the conditions of a given abstract act 220 are satisfied, the plan generator 214 queries the generative AI model 110 to generate character actions, such as the actions discussed above in conjunction with FIG. 3B. The plan reviewer and verifier 216 determines whether the actions align with predefined constraints before executing such actions within the gaming application 103. Player interactions 222 can alter the game environment data 202, e.g., saving or killing a character, which can influence ongoing narrative progression. For example, if the Ant is drowning in the Brook, a player can choose to intervene and save the ant. Similarly, the player can decide to attack or kill a character, thereby altering game environment data 202 and requiring the game state data 212 to dynamically adjust how subsequent events take place.

FIG. 3C illustrates the generated acts 310 within the game environment data 202, illustrating how the plan generator 214, in coordination with the game state engine 210, can converts abstract acts 220 into instantiated narrative events. The events can be influenced by character information 204 (e.g., goals, traits), location information 206 (e.g., spatial settings, terrain properties), and action schema information 208 associated with game environment data 202. The result can include a sequence of four acts in which characters engage in emergent storytelling. The generative AI model 110 can contribute AI-driven actions, while the plan reviewer and verifier 216 can ensure that each generated act aligns with predefined game constraints so that narrative cohesion is preserved.

As shown in FIG. 3C, Act 1, labeled “Some Character Got Into An Accident”, begins when the Ant, noticing leaves across the Brook, decides to execute the MoveTo (Brook) action. Upon arrival, the Ant slips into the water by performing the SlipIntoWater ( ) action. The plan generator 214 identifies these events based on environmental factors stored in the location information 206 and monitored by the game state engine 210.

As shown in FIG. 3C, Act 2, labeled “Some Character Saved [Ant]”, begins when the Dove, based on personality traits and goals stored in the character information 204, moves to the Brook (MoveTo (Brook)) to check on the Ant. Upon observing the Ant in danger, the Dove executes the Save (Ant) action. Here, the plan generator 214 queries the generative AI model 110 to generate the decision-making process of the Dove, and the plan reviewer and verifier 216 evaluates the proposed action against the action schema information 208 to identify any potential constraints before reflecting the action in the game environment data 202.

As shown in FIG. 3C, Act 3, labeled “[Dove] Got Into A Different Accident”, introduces movements of the Hunter. Motivated by predefined objectives (e.g., seeking targets at the Brook), the Hunter executes MoveTo (Brook). Observing the Dove distracted while saving the Ant, the Hunter initiates the TryToKill (Dove) action. The event originates from the character of the Hunter in character information 204 and is validated by the game state engine 210. The plan generator 214 generates the action, and the plan reviewer and verifier 216 evaluates compliance with applicable constraints before reflecting the action in the game environment data 202.

As additionally shown in FIG. 3C, Act 4, labeled “[Ant] Saved [Dove]”, ends the sequence in the Acts by allowing the Ant to respond to the Hunter. Sensing the threat, the Ant triggers the Think ( ) action to evaluate viable responses that are acceptable in view of personality traits associated with the Ant. The Ant opts to interfere and executes the TryToKill (Hunter) action, aiming to protect the Dove by disrupting the Hunter. In response, the game state engine 210 triggers the plan generator 214 to generate actions based on the character information 204, and the plan reviewer and verifier 216 evaluates actions consistency before finalizing the action in game environment data 202.

FIG. 3D illustrates a characters simulation 312 at a transitional end state in the gaming application 103, with the story set to continue. Following the events in FIG. 3C, the characters determine that they should relocate to the Oak Tree, which reflects updated game state data 212. In particular, the Ant, recently rescued by the Dove, seeks the Oak Tree as a safer place to find food and recover. The Dove, having just saved the Ant, decides to head to the Oak Tree for rest and potential new encounters. The Hunter, who remains driven by the goal of finding suitable targets, anticipates opportunities near the Oak Tree and chooses to relocate.

Accordingly, all three characters execute the MoveTo (OakTree) action, which is generated by the plan generator 214 after querying the generative AI model 110. The plan reviewer and verifier 216 evaluates the actions compliance with character information 204, and location information 206. Player interactions 222, environmental changes, and ongoing character goals can continue to shape emergent storytelling, further demonstrating how abstract acts 220 can be used to guide real-time narrative adaptation in the gaming application 103.

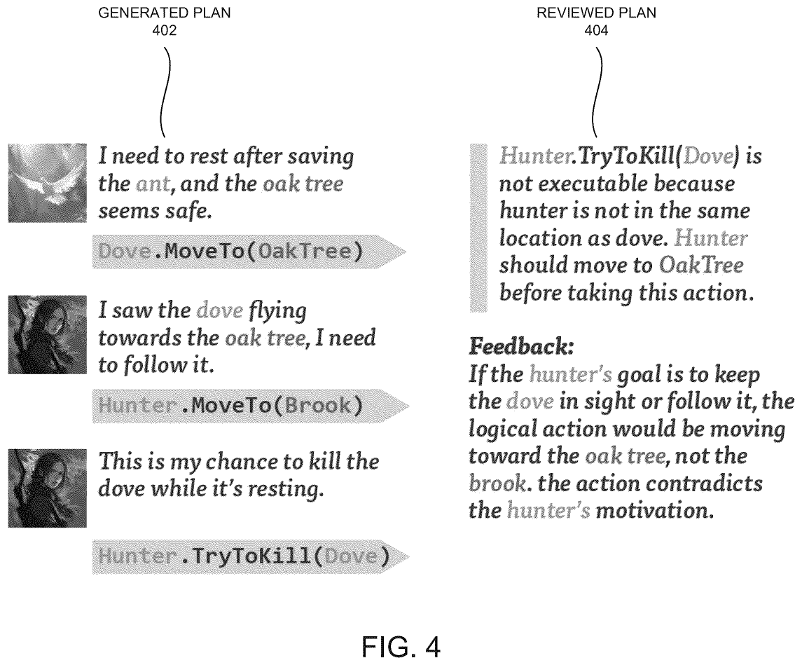

FIG. 4 illustrates a conceptual diagram of an interplay between the plan generator 214 and the plan reviewer and verifier 216, according to some embodiments. As shown in FIG. 4, in a generated plan 402, the Dove and the Hunter both have actions proposed by the plan generator 214 based on goals and the game state data 212. Specifically, the Dove decides to move to the Oak Tree for rest, while the Hunter attempts to move to the Brook and to kill the Dove by executing TryToKill (Dove) action.

In reviewed plan 404, the plan reviewer and verifier 216 identifies an inconsistency. In particular, the attempt of the Hunter to attack the Dove should not be carried out because the Hunter and the Dove are positioned in different locations within the gaming application 103. The plan verifier and reviewer 216 further notes that, given the motivation of the Hunter to pursue the Dove, moving to the Brook contradicts the goal of staying within range of the Dove at the Oak Tree. Consequently, the plan reviewer and verifier 216 provides feedback directing the Hunter to move to the Oak Tree before attempting any attack on the Dove. Accordingly, interactions between the plan generator 214 and the plan reviewer and verifier 216 can detect and resolve conflicts associated with actions within the gaming application 103.

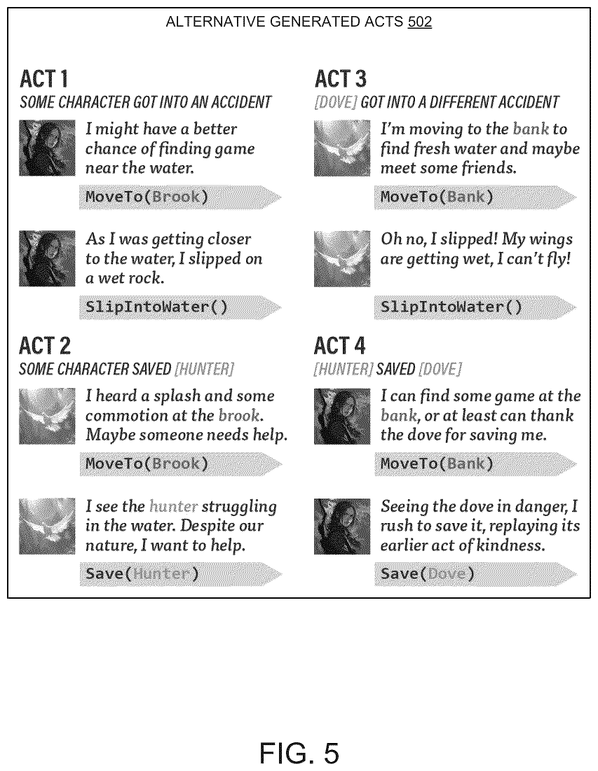

FIG. 5 illustrates a conceptual diagram of alternative generated acts relative to those discussed above in conjunction with FIGS. 3A-3D, according to some embodiments. In particular, and as shown in FIG. 5, in the alternative generated acts 502, the Ant has perished due to a simulated event such as Hunter killing Ant, one or more player interactions 222, or the like. As shown in FIG. 5, Hunter and Dove progress through a similar sequence of four Acts involving mutual assistance. The narrative opens with Act 1, labeled “Some Character Got Into An Accident”, where Hunter slips into the water at the Brook. The subsequent act, Act 2, labeled “Some Character Saved [Hunter]”, demonstrates motivation on part of the Dove to move to the Brook to rescue the Hunter. Act 3, labeled “[Dove] Got Into A Different Accident”, focuses on the Dove slipping and requiring help. In Act 4, labeled “[Hunter] Saved [Dove]”, the Hunter rushes to save the Dove in gratitude for the earlier kindness that Dove showed the Hunter.

Throughout alternative generated acts 502, the plan generator 214 queries the generative AI model 110 for narratives that align with the game environment data 202, where Ant is no longer present. Plan reviewer and verifier 216 can evaluate proposed actions against character locations, adherence to attributes from character information 204, compliance with constraints defined in the action schema information 208, and so on. Upon validation, the game environment data 202 is updated to reflect the actions, and the gaming application 103 is updated accordingly.

It is noted that the example sequences illustrated in FIGS. 3A-3D and 4-5 are not meant to be limiting, and that the sequences can include any amount, type, form, etc., of information, scenarios, transitions, etc., at any level of granularity, consistent with the scope of this disclosure.

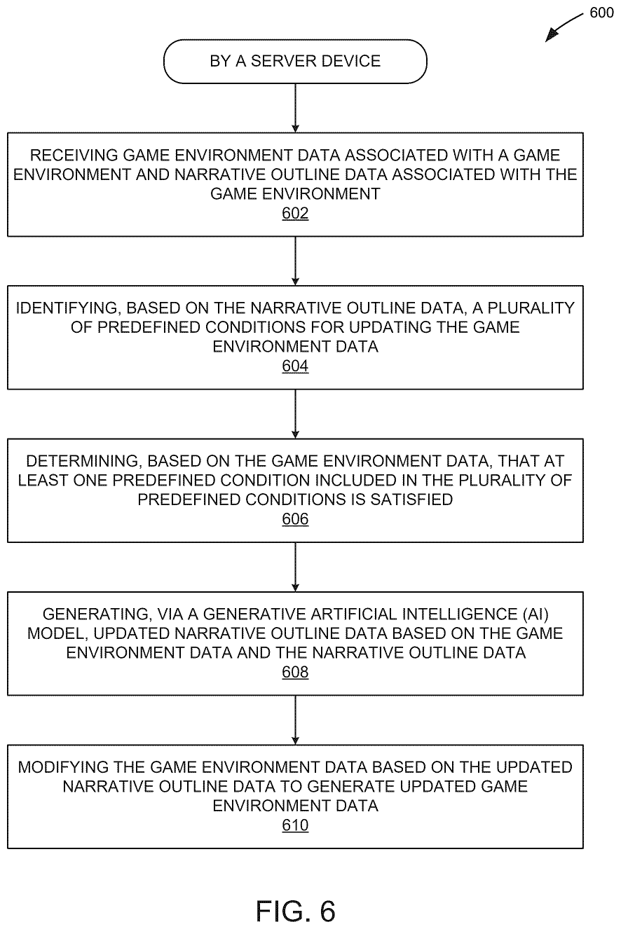

FIG. 6 illustrates a method 600 for generating dynamic narratives in gaming environments, according to some embodiments. As shown in FIG. 6, the method 600 begins at step 602, where the server device 106 receives game environment data associated with a game environment and narrative outline data associated with the game environment (e.g., as described above in conjunction with FIGS. 1-5).

At step 604, the server device 106 identifies, based on the narrative outline data, a plurality of predefined conditions for updating the game environment data (e.g., as described above in conjunction with FIGS. 1-5).

At step 606, the server device 106 determines, based on the game environment data, that at least one predefined condition included in the plurality of predefined conditions is satisfied (e.g., as described above in conjunction with FIGS. 1-5).

At step 608, the server device 106 generates, via a generative artificial intelligence (ai) model, updated narrative outline data based on the game environment data and the narrative outline data (e.g., as described above in conjunction with FIGS. 1-5).

At step 610, the server device 106 modifies the game environment data based on the updated narrative outline data to generate updated game environment data (e.g., as described above in conjunction with FIGS. 1-5).

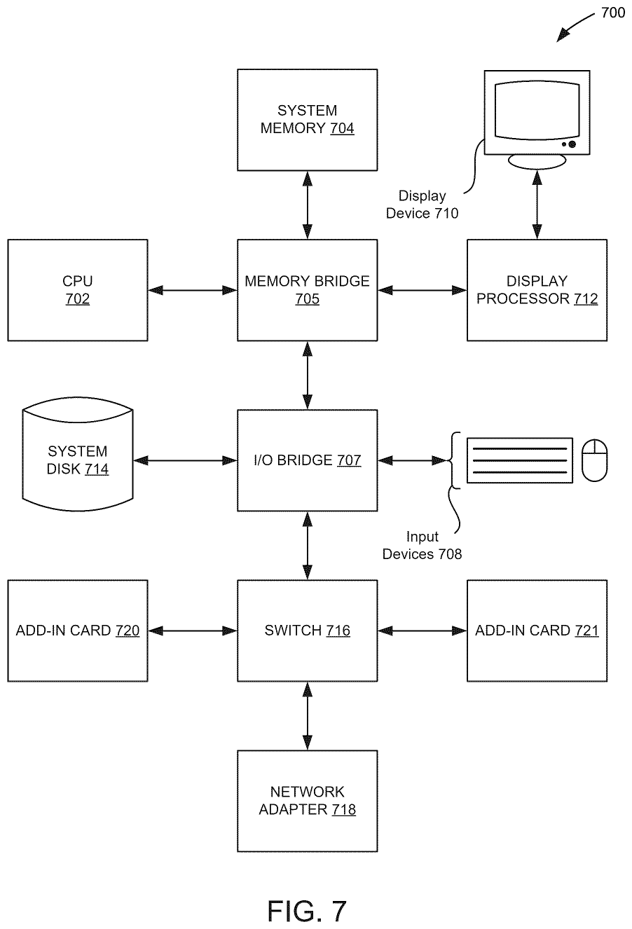

FIG. 7 is a more detailed illustration of a computing device that can implement the functionalities of the entities illustrated in FIG. 1, according to various embodiments. This figure in no way limits or is intended to limit the scope of the various embodiments. In various implementations, system 700 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 700 may be coupled together to practice one or more aspects of the various embodiments.

As shown, system 700 includes a central processing unit (CPU) 702 and a system memory 704 communicating via a bus path that may include a memory bridge 705. CPU 702 includes one or more processing cores, and, in operation, CPU 702 is the master processor of system 700, controlling and coordinating operations of other system components. System memory 704 stores software applications and data for use by CPU 702. CPU 702 runs software applications and optionally an operating system. Memory bridge 705, which may be, e.g., a Northbridge chip, is connected via a bus or other communication path (e.g., a HyperTransport link) to an I/O (input/output) bridge 707. I/O bridge 707, which may be, e.g., a Southbridge chip, receives user input from one or more user input devices 708 (e.g., keyboard, mouse, joystick, digitizer tablets, touch pads, touch screens, still or video cameras, motion sensors, and/or microphones) and forwards the input to CPU 702 via memory bridge 705.

A display processor 712 is coupled to memory bridge 705 via a bus or other communication path (e.g., a PCI Express, Accelerated Graphics Port, or HyperTransport link); in one embodiment display processor 712 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 704.

Display processor 712 periodically delivers pixels to a display device 710 (e.g., a screen or conventional CRT, plasma, OLED, SED or LCD based monitor or television). Additionally, display processor 712 may output pixels to film recorders adapted to reproduce computer generated images on photographic film. Display processor 712 can provide display device 710 with an analog or digital signal. In various embodiments, one or more of the various graphical user interfaces set forth in FIG. 3 are displayed to one or more users via display device 710, and the one or more users can input data into and receive visual output from those various graphical user interfaces.

A system disk 714 is also connected to I/O bridge 707 and may be configured to store content and applications and data for use by CPU 702 and display processor 712. System disk 714 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 716 provides connections between I/O bridge 707 and other components such as a network adapter 718 and various add-in cards 720 and 721. Network adapter 718 allows system 700 to communicate with other systems via an electronic communications network, and may include wired or wireless communication over local area networks and wide area networks such as the Internet.

Other components (not shown), including USB or other port connections, film recording devices, and the like, may also be connected to I/O bridge 707. For example, an audio processor may be used to generate analog or digital audio output from instructions and/or data provided by CPU 702, system memory 704, or system disk 714. Communication paths interconnecting the various components in FIG. 7 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 712 incorporates circuitry optimized for graphics and video processing, including, for example, video output circuitry, and constitutes a graphics processing unit (GPU). In another embodiment, display processor 712 incorporates circuitry optimized for general purpose processing. In yet another embodiment, display processor 712 may be integrated with one or more other system elements, such as the memory bridge 705, CPU 702, and I/O bridge 707 to form a system on chip (SoC). In still further embodiments, display processor 712 is omitted and software executed by CPU 702 performs the functions of display processor 712.

Pixel data can be provided to display processor 712 directly from CPU 702. In some embodiments, instructions and/or data representing a scene are provided to a render farm or a set of server computers, each similar to system 700, via network adapter 718 or system disk 714. The render farm generates one or more rendered images of the scene using the provided instructions and/or data. These rendered images may be stored on computer-readable media in a digital format and optionally returned to system 700 for display. Similarly, stereo image pairs processed by display processor 712 may be output to other systems for display, stored in system disk 714, or stored on computer-readable media in a digital format.

Alternatively, CPU 702 provides display processor 712 with data and/or instructions defining the desired output images, from which display processor 712 generates the pixel data of one or more output images, including characterizing and/or adjusting the offset between stereo image pairs. The data and/or instructions defining the desired output images can be stored in system memory 704 or graphics memory within display processor 712. In an embodiment, display processor 712 includes 3D rendering capabilities for generating pixel data for output images from instructions and data defining the geometry, lighting shading, texturing, motion, and/or camera parameters for a scene. Display processor 712 can further include one or more programmable execution units capable of executing shader programs, tone mapping programs, and the like.

Further, in other embodiments, CPU 702 or display processor 712 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 702, display processor 712, or one or more other processing devices or any combination of these different processors.

CPU 702, render farm, and/or display processor 712 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 700 may be a robot or robotic device and may include CPU 702 and/or other processing units or devices and system memory 704. In such embodiments, system 700 may or may not include other elements shown in FIG. 7. System memory 704 and/or other memory units or devices in system 700 may include instructions that, when executed, cause the robot or robotic device represented by system 700 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 704 is connected to CPU 702 directly rather than through a bridge, and other devices communicate with system memory 704 via memory bridge 705 and CPU 702. In other alternative topologies display processor 712 is connected to I/O bridge 707 or directly to CPU 702, rather than to memory bridge 705. In still other embodiments, I/O bridge 707 and memory bridge 705 might be integrated into a single chip. The particular components shown herein are optional; for instance, any number of add-in cards or peripheral devices might be supported. In some embodiments, switch 716 is eliminated, and network adapter 718 and add-in cards 720, 721 connect directly to I/O bridge 707.

In sum, the embodiments set forth techniques for co-authoring dynamic plots using LLM based character simulations via narrative planning. In particular, the disclosed techniques provide a dynamic process for defining a game environment, which includes character information, location details, and an action schema, along with a high-level narrative outline consisting of abstract acts. The abstract acts serve as a framework for the narrative, which is dynamically instantiated into sequences of character actions during gameplay based on the evolving game state. Upon detecting satisfaction of the prerequisites of an abstract act, the disclosed techniques generate character actions that align with the narrative outline and execute actions within the game environment. Player interventions are incorporated into the game state, such that the evolving story adapts to both character behaviors and player inputs. As a result, the techniques combine real-time narrative generation, player-driven adaptability, and AI-driven character simulation to generate an engaging, coherent, and scalable narrative workflow.

One technical advantage of the disclosed techniques relative to conventional approaches is that the disclosed techniques provide centralized control over emergent narratives while preserving the autonomy of game characters. In particular, the disclosed techniques enable narrative coherence to be maintained, including when multiple characters interact dynamically in real-time. Another technical advantage is that the disclosed techniques eliminate the need for pre-scripted branching storylines by enabling abstract, high-level story outlines to be dynamically instantiated into character actions, which increases the scalability of narrative generation. Additionally, the disclosed techniques enable real-time integration of player actions, thereby allowing stories and narratives to evolve based on both character simulations and player input.
1. In some embodiments, a computer-implemented method for generating dynamic narratives in gaming environments comprises receiving game environment data associated with a game environment and narrative outline data associated with the game environment; identifying, based on the narrative outline data, a plurality of predefined conditions for updating the game environment data; determining, based on the game environment data, that at least one predefined condition included in the plurality of predefined conditions is satisfied; generating, via a generative artificial intelligence (AI) model, updated narrative outline data based on the game environment data and the narrative outline data; and modifying the game environment data based on the updated narrative outline data to generate updated game environment data.
2. The computer-implemented method of clause 1, wherein the game environment data comprises character information that includes at least one of location information that defines locations of a plurality of characters included in the game environment, or action schema information that defines permissible actions of the plurality of characters.
3. The computer-implemented method of clause 1, wherein the narrative outline data comprises at least one of abstract act information, prerequisite condition information, or narrative constraint information.
4. The computer-implemented method of clause 1, wherein determining that at least one predefined condition is satisfied comprises determining that at least one event has occurred within the game environment.
5. The computer-implemented method of clause 4, wherein the at least one event comprises at least one of at least one character executing a particular action or moving to a particular location within the game environment.
6. The computer-implemented method of clause 4, wherein the at least one event comprises receiving at least one input from a user.
7. The computer-implemented method of clause 1, wherein the updated narrative outline data comprises at least one change to at least one character dialogue within the game environment.
8. The computer-implemented method of clause 1, further comprising, prior to modifying the game environment data, determining that the updated narrative outline data is compatible with at least one predefined constraint included in the updated narrative outline data.
9. The computer-implemented method of clause 8, wherein determining that the updated narrative outline data is compatible with the at least one predefined constraint comprises determining that the updated narrative outline data does not violate at least one rule specified in the at least one predefined constraint.
10. The computer-implemented method of clause 1, wherein the updated game environment data comprises at least one change to at least one property of the game environment.
11. In some embodiments, one or more non-transitory computer readable media store instructions that, when executed by one or more processors, cause the one or more processors to generate dynamic narratives in gaming environments, by performing the operations of receiving game environment data associated with a game environment and narrative outline data associated with the game environment; identifying, based on the narrative outline data, a plurality of predefined conditions for updating the game environment data; determining, based on the game environment data, that at least one predefined condition included in the plurality of predefined conditions is satisfied; generating, via a generative artificial intelligence (AI) model, updated narrative outline data based on the game environment data and the narrative outline data; and modifying the game environment data based on the updated narrative outline data to generate updated game environment data.
12. The one or more non-transitory computer readable media of clause 11, wherein generating the updated narrative outline data comprises receiving output data from the generative AI model in response to providing the game environment data and the narrative outline data to the generative AI model; and generating the updated narrative outline data based on the output data.
13. The one or more non-transitory computer readable media of clause 11, wherein the operations further include, in response to identifying at least one conflict between the updated narrative outline data and the game environment data, revising the updated narrative outline data to eliminate the at least one conflict.
14. The one or more non-transitory computer readable media of clause 11, wherein the game environment is implemented on at least one of an endpoint computing device or a server computing device.
15. The one or more non-transitory computer readable media of clause 11, wherein the game environment data comprises character information that includes at least one of location information that defines locations of a plurality of characters included in the game environment, or action schema information that defines permissible actions of the plurality of characters.
16. The one or more non-transitory computer readable media of clause 11, wherein the narrative outline data comprises at least one of abstract act information, prerequisite condition information, or narrative constraint information.
17. The one or more non-transitory computer readable media of clause 11, wherein determining that at least one predefined condition is satisfied comprises determining that at least one event has occurred within the game environment.
18. The one or more non-transitory computer readable media of clause 17, wherein the at least one event comprises at least one of at least one character executing a particular action or moving to a particular location within the game environment.
19. The one or more non-transitory computer readable media of clause 17, wherein the at least one event comprises receiving at least one input from a user.
20. In some embodiments, a computer system comprises one or more memories that include instructions, and one or more processors that are coupled to the one or more memories and, when executing the instructions, are configured to generate dynamic narratives in gaming environments, by performing the operations of receiving game environment data associated with a game environment and narrative outline data associated with the game environment; identifying, based on the narrative outline data, a plurality of predefined conditions for updating the game environment data; determining, based on the game environment data, that at least one predefined condition included in the plurality of predefined conditions is satisfied; generating, via a generative artificial intelligence (AI) model, updated narrative outline data based on the game environment data and the narrative outline data; and modifying the game environment data based on the updated narrative outline data to generate updated game environment data.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating dynamic narratives in gaming environments, the method comprising:
receiving game environment data associated with a game environment and narrative outline data associated with the game environment;
identifying, based on the narrative outline data, a plurality of predefined conditions for updating the game environment data;
determining, based on the game environment data, that at least one predefined condition included in the plurality of predefined conditions is satisfied;
generating, via a generative artificial intelligence (AI) model, updated narrative outline data based on the game environment data and the narrative outline data; and
modifying the game environment data based on the updated narrative outline data to generate updated game environment data.

2. The computer-implemented method of claim 1, wherein the game environment data comprises character information that includes at least one of location information that defines locations of a plurality of characters included in the game environment, or action schema information that defines permissible actions of the plurality of characters.

3. The computer-implemented method of claim 1, wherein the narrative outline data comprises at least one of abstract act information, prerequisite condition information, or narrative constraint information.

4. The computer-implemented method of claim 1, wherein determining that at least one predefined condition is satisfied comprises determining that at least one event has occurred within the game environment.

5. The computer-implemented method of claim 4, wherein the at least one event comprises at least one of at least one character executing a particular action or moving to a particular location within the game environment.

6. The computer-implemented method of claim 4, wherein the at least one event comprises receiving at least one input from a user.

7. The computer-implemented method of claim 1, wherein the updated narrative outline data comprises at least one change to at least one character dialogue within the game environment.

8. The computer-implemented method of claim 1, further comprising, prior to modifying the game environment data, determining that the updated narrative outline data is compatible with at least one predefined constraint included in the updated narrative outline data.

9. The computer-implemented method of claim 8, wherein determining that the updated narrative outline data is compatible with the at least one predefined constraint comprises determining that the updated narrative outline data does not violate at least one rule specified in the at least one predefined constraint.

10. The computer-implemented method of claim 1, wherein the updated game environment data comprises at least one change to at least one property of the game environment.

11. One or more non-transitory computer readable media storing instructions that, when executed by one or more processors, cause the one or more processors to generate dynamic narratives in gaming environments, by performing the operations of:
receiving game environment data associated with a game environment and narrative outline data associated with the game environment;
identifying, based on the narrative outline data, a plurality of predefined conditions for updating the game environment data;
determining, based on the game environment data, that at least one predefined condition included in the plurality of predefined conditions is satisfied;
generating, via a generative artificial intelligence (AI) model, updated narrative outline data based on the game environment data and the narrative outline data; and
modifying the game environment data based on the updated narrative outline data to generate updated game environment data.

12. The one or more non-transitory computer readable media of claim 11, wherein generating the updated narrative outline data comprises:
receiving output data from the generative AI model in response to providing the game environment data and the narrative outline data to the generative AI model; and
generating the updated narrative outline data based on the output data.

13. The one or more non-transitory computer readable media of claim 11, wherein the operations further include, in response to identifying at least one conflict between the updated narrative outline data and the game environment data, revising the updated narrative outline data to eliminate the at least one conflict.

14. The one or more non-transitory computer readable media of claim 11, wherein the game environment is implemented on at least one of an endpoint computing device or a server computing device.

15. The one or more non-transitory computer readable media of claim 11, wherein the game environment data comprises character information that includes at least one of location information that defines locations of a plurality of characters included in the game environment, or action schema information that defines permissible actions of the plurality of characters.

16. The one or more non-transitory computer readable media of claim 11, wherein the narrative outline data comprises at least one of abstract act information, prerequisite condition information, or narrative constraint information.

17. The one or more non-transitory computer readable media of claim 11, wherein determining that at least one predefined condition is satisfied comprises determining that at least one event has occurred within the game environment.

18. The one or more non-transitory computer readable media of claim 17, wherein the at least one event comprises at least one of at least one character executing a particular action or moving to a particular location within the game environment.

19. The one or more non-transitory computer readable media of claim 17, wherein the at least one event comprises receiving at least one input from a user.

20. A computer system, comprising:
one or more memories that include instructions; and
one or more processors that are coupled to the one or more memories and, when executing the instructions, are configured to generate dynamic narratives in gaming environments, by performing the operations of:
receiving game environment data associated with a game environment and narrative outline data associated with the game environment;
identifying, based on the narrative outline data, a plurality of predefined conditions for updating the game environment data;
determining, based on the game environment data, that at least one predefined condition included in the plurality of predefined conditions is satisfied;
generating, via a generative artificial intelligence (AI) model, updated narrative outline data based on the game environment data and the narrative outline data; and
modifying the game environment data based on the updated narrative outline data to generate updated game environment data.
